(19) United States
(12) Patent Application Publication
(10) Pub. No.: US 2014/0210537 A1
(43) Pub. Date: Jul. 31, 2014

(54) ELECTRONIC DEVICE

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: ZHI-GANG LIU, Shenzhen (CN); YI-HSIANG KAO, New Taipei (TW)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/019,572

(22) Filed: Sep. 6, 2013

(30) Foreign Application Priority Data
Jan. 29, 2013 (CN) 2013100327606

(51) Int. Cl. G05F 1/46

(52) U.S. Cl. CPC G05F 1/46
USPC 327/306

(57) ABSTRACT

An electronic device is powered by a first power supply and connected to an external device powered by a second power supply. The electronic device comprises a master controller, a conversion module, and a detection module. The master controller outputs first information. The conversion module converts the first information into second information based on a first voltage from the first power supply and a second voltage from the second power supply to control the external device to execute corresponding functions. The detection module is connected with the first power supply and the conversion module, and generates a pull-up voltage when the voltage of the second power supply is in an abnormal state. The conversion module further converts the first information into a second information based on the voltage of the first power supply and the pull-up voltage. The pull-up voltage is larger than the first voltage.

### BACKGROUND

1. Technical Field

The present disclosure relates to an electronic device.

2. Description of Related Art

Most electronic devices include an inter integrated circuit (I2C). The I2C includes a serial clock line (SCL) and a serial data line (SDA) for transmitting messages. The electronic device connected with an external device includes a first power supply and a mirco controller unit (MCU). The external device includes a second power supply and a slave controller. The master controller includes a first terminal connected to the SCL and a second terminal connected to the SDA. The slave controller includes a third terminal connected to the SCL and a fourth terminal connected to the SDA. The message transmitted from the master controller to the slave controller begins with a start bit and stops with a stop bit. The start bit is indicated by a high-to-low transition of SDA with SCL being high; the stop bit is indicated by a low-to-high transition of SDA with SCL being high. The first power supply and the second power supply are respectively connected to the SCL and the SDA. However, when the second power supply of the external device becomes lower than a predetermined value, the SCL and the SDA are locked in logic low level, thus the master controller is unable to generate the start bit or the stop bit.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is a block diagram of an electronic device in accordance with one embodiment.

FIG. 2 is a circuit diagram of the electronic device of FIG. 1 in accordance with one embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at “least one.”

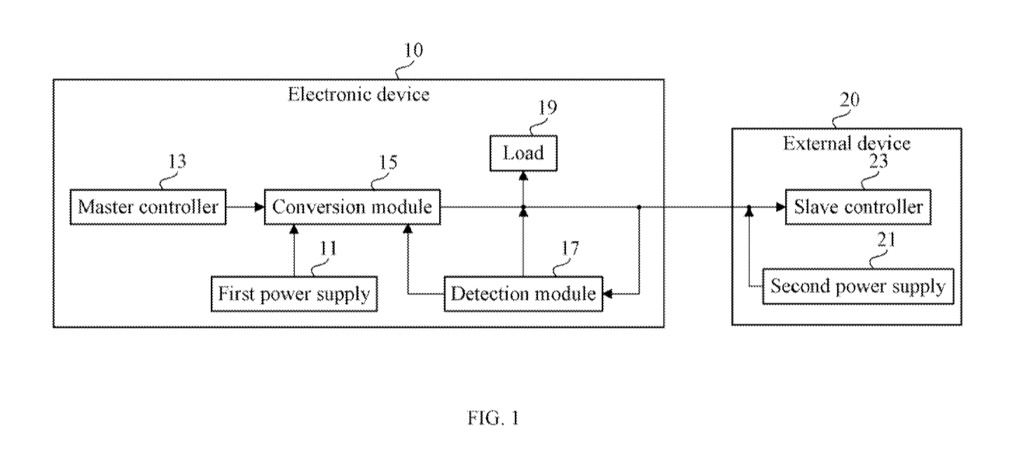

FIG. 1 shows an electronic device 10 of one embodiment of the present disclosure. The electronic device 10 is capable of controlling an external device 20 through an inter integrated circuit (I2C) connected with the electronic device 10 when the voltage of the external device 20 is in an abnormal state. In the embodiment, the external device 20 can be a DVD player or a data storage device.

The electronic device 10 includes a first power supply 11, a master controller 13, a conversion module 15, a detection module 17, and a load 19.

The first power supply 10 provides a first voltage. In the embodiment, the first voltage is 3.3V.

The master controller 13 is used for outputting first clock information and first data information. The first clock information and the first data information are serial digital signals changing from logic high level to logic low level and vice versa.

The conversion module 15 receives the first voltage from the first power supply 11 and a second voltage in a normal state from the external device 20. The conversion module 15 converts the first clock information into second clock information and converts the first data information into second data information. In the embodiment, the logic level of the second clock information is reversed with that of the first clock information, and the logic level of the second data information is reversed with that of the first data information.

The detection module 17 detects whether the second voltage from the external device 20 is less than the first voltage. If the second voltage is less than the first voltage, the second voltage is in a normal state and the detection module 17 generates a pull-up voltage to the voltage conversion 15. If the second voltage is, more than or equal to the first voltage, the second voltage is in an abnormal state and the detection module 17 stops generating the pull-up voltage. In the embodiment, the pull-up voltage is 5V.

The conversion module 15 continues to covert the first clock information into second clock information and converts the first data information into second clock information based on the first voltage and the pull-up voltage.

The load 19 receives the second clock information and the second data information to execute a corresponding function.

The external device 20 includes a second power supply 21 and a slave controller 23.

The second power supply 21 provides the second voltage.

The slave controller 23 receives the second clock information and the second data information to execute a corresponding function.

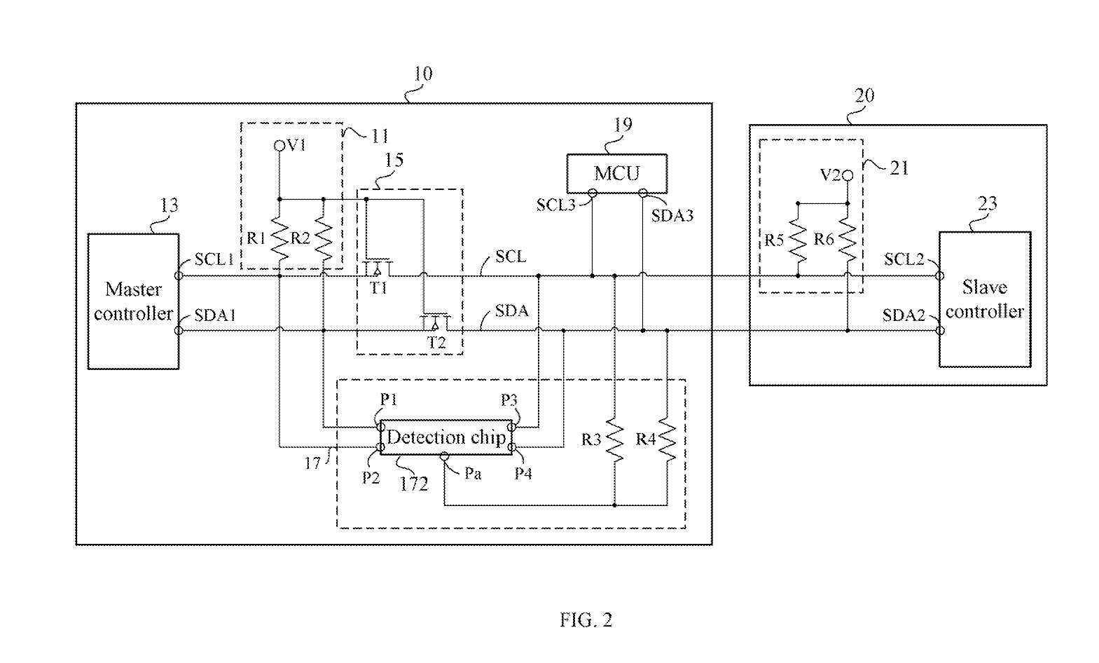

FIG. 2 shows that the first power supply 11 includes a first power pin V1, a first resistor RL and a second resistor R2. Opposite terminals of the first resistor R1 and a second resistor R2 are respectively connected between the first power supply V1 and the master controller 13.

The master controller 13 includes a first serial clock pin SCL1 and a first serial data pin SDA1. The first serial clock pin SCL1 and the first serial data pin SDA1 are connected to the slave controller 23 via a serial clock line SCL and a serial data line SDA correspondingly. A terminal of the first resistor R1 is connected to the first serial clock pin SCL1. A terminal of the second resistor R2 is connected to the first serial data pin SDA1.

The conversion module 15 includes a first transistor Q1 and a second transistor Q2.

A gate of the first transistor Q1 is connected to the first power source V1. A source of the first transistor Q1 is connected to the first serial clock pin SCL1. A drain of the first transistor Q1 is connected to the second power supply 21. A gate of the second transistor Q2 is connected to the first power source V1. A source of the second transistor Q2 is connected to the first serial data pin SDA1. A drain of the second transistor Q2 is connected to the second power supply 21. In the embodiment, the first transistor Q1 and the second transistor Q2 are n-channel enhancement type MOSFET.

The detection module 17 includes a detection unit 172, a third resistor R3, and a fourth resistor R4. The detection unit 172 includes a first detection pin P1, a second detection pin P2, a third detection pin P3, a fourth detection pin P4, and an outputting pin Pa. The first detection pin P1 is connected to the serial clock line SCL. The second detection pin P2 is connected to the first serial data line SDA. The third detection pin P3 is connected to the drain of the first transistor Q1. The fourth detection pin P4 is connected to the drain of the second transistor Q2. A terminal of the third resistor R3 is connected to the drain of the first transistor Q1. An opposite terminal of the third resistor R3 is connected to the outputting pin Pa. A terminal of the fourth resistor R4 is connected to the drain of the second transistor Q2. An opposite terminal of the fourth resistor R4 is connected to the outputting pin Pa.

The load 19 includes a second serial clock pin SCL2 and a second serial data pin SDA2. The second serial clock pin SCL2 is connected to the first serial clock pin SCL1 via the serial clock line SCL. The second serial data pin SDA2 is connected to the first serial data pin SDA1 via the serial data line SDA.

The second power supply 21 includes a second power source V2, a fifth resistor R5, and a sixth resistor R6. A terminal of the fifth resistor R5 is connected to the first serial clock pin SCL1. An opposite terminal of the fifth resistor R4 is connected to the second power source V2. A terminal of the sixth resistor R6 is connected to the first serial data pin SDA1. An opposite terminal of the sixth resistor R6 is connected to the second power source V2.

The second controller 23 includes a third serial clock pin SCL3 and a third serial data pin SDA3. The third serial clock pin SCL3 is connected to the serial clock line SCL. The third serial data pin SDA3 is connected to the serial data line SDA.

The principle of the electronic device 10 is described, when the voltage of the first detection pin P1 is less than the voltage of the third detection pin P3 and the voltage of the second detection pin P2 is less than the voltage of the fourth detection pin P4, the outputting pin Pa stops outputting the pull-up voltage. The voltage difference between the gate and the drain of the first transistor Q1 is more than 0V, the first transistor Q1 is in an active state to convert the first clock information to the second clock information. The voltage difference between the gate and the drain of the second transistor Q2 is more than 0V, the second transistor Q2 is in an active state to convert the first data information to the second data information. When the voltage of the first detection pin P1 is more than or equal to the voltage of the third detection pin P3 or the voltage of the second detection pin P2 is more than or equal to the voltage of the fourth detection pin P4, the outputting pin Pa outputs the pull-up voltage. The drain of the first transistor Q1 and the drain of the second transistor Q2 are pulled up to be equal to the pull-up voltage, thus the first transistor Q1 and the second transistor Q2 are still in an active state. As a result, the master controller 21 also outputs the first clock information and the first data information to control the load 19.

In use, when the voltage of the external device 20 connected to the master controller 21 is in the abnormal state, the detection module 17 outputs the pull-up voltage to enable the conversion module 15. Therefore, the electronic device 10 can also output the clock information and the data information when the voltage generated by the connected external device 20 is in the abnormal state.

It is to be understood, however, that even though information and advantages of the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. An electronic device powered by a first power supply connected to an external device powered by a second power supply, comprising:
a master controller capable of outputting first information;
a conversion module capable of converting the first information into second information based on a first voltage from the first power supply and a second voltage from the second power supply for controlling the external device to execute corresponding functions; and
a detection module connected with the first power supply and the conversion module;
wherein when the voltage of the second power supply is in an abnormal state, the detection module generates a pull-up voltage, the conversion module converts the first information into a second information based on the voltage of the first power supply and the pull-up voltage, the pull-up voltage is larger than the first voltage.

2. The electronic device of claim 1, wherein the detection module further detects whether the second voltage is less than the first voltage, the second voltage is in the abnormal state when the second voltage is less than the first voltage.

3. The electronic device of claim 1, wherein the conversion module comprises a first transistor and a second transistor; a gate of the first transistor is connected to the first power supply, a source of the first transistor is connected to the master controller, a drain of the first transistor is connected to the second power supply; a gate of the second transistor is connected to the first power supply, a source of the second transistor is connected to the master controller, a drain of the second transistor is connected to the second power supply.

4. The electronic device of claim 3, wherein the first transistor and the second transistor are both n-channel enhancement type metal oxide semiconductor field effect transistors.

5. The electronic device of claim 1, wherein the first information outputted by the master controller comprises first clock information and first data information.

6. The electronic device of claim 5, wherein the master controller comprises a first serial clock pin and a first serial data pin; the first serial clock pin is used for outputting the first clock information, and the first serial data pin is used for outputting the first data information.

7. The electronic device of claim 1, wherein the first information and the second information are serial digital signals changing between logic high level and logic low level alternatively; the logic level of the second information is reversed with that of the first information.
